(19) United States
(12) Patent Application Publication
(10) Pub. No.: US 2022/0399850 A1
(43) Pub. Date: Dec. 15, 2022

(54) Adaptive Solar Tracking System

(71) Applicant: Solar Pivot Power, Wabasha, MN (US)

(72) Inventors: Dale Hanks, Wabasha, MN (US); Uttam Singh, Austin, TX (US); Dan Moravec, Wabasha, MN (US)

(21) Appl. No.: 17/841,342

(22) Filed: Jun. 15, 2022

Related U.S. Application Data
(60) Provisional application No. 63/210,745, filed on Jun. 15, 2021.

(51) Int. Cl. H02S 20/32

(52) U.S. Cl. CPC H02S 20/32

(57) ABSTRACT

A solar tracking system is disclosed. The solar tracking system may comprise at least one processor, a memory coupled to the at least one processor, a carriage mount, a carriage, an altitude motor connected to the carriage, an azimuth motor connected to the carriage, and a tracking application, residing in the memory and executed by the at least one processor. The tracking application may be configured to run the altitude motor and azimuth motor in a predictive manner, such that a solar panel connected to the carriage is positioned in a way to increase solar irradiation of the solar panel.

### PRIORITY CLAIM

The present application claims the benefit of priority of U.S. Provisional Patent Application Ser. No. 63/210,745, titled “Adaptive Solar Tracking System and Portable Mechanical Solar Tracker,” filed Jun. 15, 2021, which is incorporated herein by reference.

### BACKGROUND

Methods, apparatuses, and computer program products for tracking the path of the sun may be useful for improving solar energy collection. Methods, apparatuses, and computer program products for improved placement of a device relative to the sun, including adaptive technology designed to reduce energy consumed in order to track the movement of the sun and provide smoother movements as the tracking system follows the sun predictively. Embodiments of the adaptive technology and tracking system are described herein.

### SUMMARY

One embodiment provides a solar tracking system comprising at least one processor, a memory coupled to the at least one processor, a carriage mount, a carriage, an altitude motor connected to the carriage, an azimuth motor connected to the carriage, and a tracking application, residing in the memory and executed by the at least one processor. The tracking application is configured to run the altitude motor and azimuth motor such that a solar panel connected to the carriage is positioned in a way to increase solar irradiation of the solar panel.

Another embodiment provides a solar panel mount comprising at least one processor, a plurality of sensors connected to the at least one processor, a memory coupled to the at least one processor, and persistent storage coupled to the at least one processor. The solar panel mount further comprises a carriage mount and a carriage. An altitude drive including an altitude drive shaft and an altitude motor is configured to control a altitude rotation of the carriage mount, and an azimuth drive including an azimuth drive shaft and an azimuth motor is drive configured to control an azimuth rotation of the carriage mount. A dual axis tracking assembly housing contains the altitude drive and the azimuth drive.

Another embodiment provides a non-transitory, computer-readable medium containing instructions that when executed by an electronic processor cause the electronic processor to control rotation of a solar panel mount, by: obtaining sun altitude data or sun azimuth data from a plurality of sensors in a learn mode; storing the sun altitude data or sun azimuth data in a persistent storage; calculating plurality of predictive sun altitude position points based on the stored sun altitude data or stored sun azimuth data; and, running a single-axis drive to rotate the solar panel mount to a desirable position based on the predictive sun altitude position points.

One or more embodiments may include a dual-axis adaptive solar tracker product comprising a base, a dual-axis mechanical drive assembly, a carriage configured to hold a separately-provided portable solar panel, an altitude drive train & motor, an azimuth drive train & motor, sensors, a battery subsystem with auxiliary solar panel and a motherboard to drive the adaptive solar tracking logic for adaptively or predictively adjusting the placement of the carriage. The base may be configured to provide lateral stability for the solar panel. The solar panel may be mounted on the carriage and secured. The motors and sensors of the dual-axis solar tracker may be connected to the motherboard, which may be powered by the battery subsystem. The dual-axis mechanical drive assembly may have gearing that facilitates rotation of the carriage about a vertical axis and about a horizontal axis (e.g., azimuth rotation), driven by an azimuth and altitude motor respectively.

In one or more embodiments the carriage assembly may be configured to be connected to a base and tilt and rotate by way of azimuth and altitude components of the mechanical drive assembly, driven by one or more azimuth and altitude motors. The azimuth and altitude motors may be configured to be directed according to adaptive solar tracking logic provided in a computer-based controller subsystem.

In one or more embodiments the solar panel may be portable. Additionally, in one or more embodiments the solar panel may be separately provided. Specific sizes and dimensions of various embodiments of this present invention may vary without deviating from the essence of the invention.

By using the adaptive solar tracking system, solar power captured may be maximized while mechanical movements, wear on components, power consumed by electronics and motors, audio/visual distractions, production cost, risk of damage, and wind resistance may be minimized.

Other aspects of the disclosure will become apparent by consideration of the detailed description and accompanying drawings.

### BRIEF DESCRIPTION OF THE DRAWINGS

FIG. 1 shows a hardware schematic for an adaptive solar tracking system.

FIG. 2 shows a front view of the base and carriage.

FIG. 3 shows a side view of the base and carriage.

FIG. 4 shows a front view of the dual-axis mechanical drive assembly.

FIG. 5 shows a side view of the dual-axis mechanical drive assembly.

FIG. 6 shows a component comprising the altitude drive train.

FIG. 7 shows components comprising the azimuth drive train.

FIG. 8 details a flowchart for handling of the ON/OFF switch.

FIG. 9 illustrates a flowchart for the power ON sequence for the computer program containing the adaptive solar tracking logic.

FIG. 10 shows a shutdown sequence for the computer program containing the adaptive solar tracking logic, initiated when the switch is turned off.

FIG. 11 shows a flowchart of adaptive solar tracking logic, including learn, predictive and replay modes.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical or hydraulic connections or couplings, whether direct or indirect.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. As used within this document, the word “or” may mean inclusive or. As a non-limiting example, if examples in this document state that “item Z may comprise element A or B,” this may be interpreted to disclose an item Z comprising only element A, an item Z comprising only element B, as well as an item Z comprising elements A and B.

The Sun's coordinates may be referred to herein as azimuth and altitude. Azimuth refers to the sun's position as measured on the horizontal plane clockwise from the north pole. Altitude refers to the sun's position as measured on the vertical plane with respect to the horizon. The orientation/placement/facing of a carriage configured to carry a solar panel may be referred to herein in terms of its azimuth and altitude movement/rotation.

Usable energy harvested from solar radiation by a solar panel is often maximized when the solar radiation's angle of incidence is 0°. Studies have shown that a static solar panel may produce up to 40% less energy as compared to a solar panel that is frequently repositioned to ensure the Sun's direct light strikes the surface of the solar panel at right angle. Techniques for positioning a solar panel (also referred as solar tracking) to increase solar energy may be manual, passive or active.

Generally speaking, Earth rotates on its tilted axis (approx. 23.5°) once every 24 hours (approx.). It also revolves around the sun every 365 days (approx.). Because of Earth's tilted axis and its orbit around the sun, solar coordinates as measured on Earth's surface vary based on the latitude, time of the day and day of the Year. In addition the local time at a location is dependent on its Longitude (e.g., 4 minutes per longitude, broken into hour time zones). Active solar trackers deployed by large scale utilities or, sometimes in commercial and residential settings, may take advantage of location aware services like GPS to facilitate tracking of the sun throughout the year. Other static installations make compromised choices of fixed orientation best suited for the specific latitude and/or time of the year (in the northern hemisphere, south facing and a vertical angle tilt).

The sun's azimuth, when tracked against time, may give a sense of how the sun appears in the sky relative to a location on the Earth. The sun's Azimuth (Δ) can also be tracked relative to time. A reasonable compromise for a single axis (Azimuth) tracker might be to set the altitude such that the Angle of Incidence at Solar Noon is 0, thus enabling maximum solar power generation for a single axis tracker. An angle of incidence at solar noon=0° for a single axis azimuth tracker might be calculated using the latitude of the tracker and the day of the year (as counted from March Equinox).

Solar trackers may be configured to reposition solar energy collectors such that the energy produced is maximized due to a desirable placement in relation to the sun. Having the sunlight strike the solar panel at 90° (right-angle) throughout the day may ensure a maximized intensity of sunlight incident on the panel. The angle of sunlight reaching the solar panel in relation to the solar panel's orientation (e.g., azimuth and altitude facing) may be referred to herein as the “incidence angle” or the “angle of incidence.” A small to 0° incidence angle is often desirable for solar power generation. There may be rapid deterioration in solar power/intensity as the incidence angle increases (in some cases, 1% loss at 8, 30% loss at 45°, greater than 75% loss at 75°) and therefore a deterioration in solar energy captured by the solar panel. To achieve a small to 0° incidence angle, it may be beneficial for the solar panel to track the sun.

If the GPS coordinates of the solar panel and the date & time of measurement are known, it may be possible to determine the exact position of the sun in the sky using well-known solar calculations. If a solar tracker is self-aware of its relative position in terms of compass heading as well as tilt/roll angles, exact placement to increase or maximize solar energy collection may be possible. In a fixed-location solar installation, for example, GPS coordinates and a preset pattern may be indicated to a tracker in a set up step. However, means other than GPS may be used to track the sun in an energy-conscious manner.

Some solar tracking systems may be configured to use a continuous sensor-based approach to continuously make adjustments to follow the position of the sun. One potential downside of such approaches is that the energy consumed to continually reposition the carriage to the optimal placement may be excessive. Further, these solar tracking systems make azimuth and altitude adjustments to the carriage sequentially which may cause a robotic-like, “choppy” motion pattern. Another potential limitation of continuous sensor-based approaches is when cloudy or shady conditions exist, these solar tracking systems may seek excessively to find optimal panel placement, which may consume excessive amounts of power and may result in excessive wear and tear of the tracker equipment. However, an adaptive solar tracking system including an adaptive tracking assembly may be configured to keep track of its own movements in order to predictively position the carriage and thereby help minimize the amount of energy consumed while repositioning the carriage.

By using a predictive algorithm, it may be possible to minimize the movements of the carriage of the adaptive solar tracking system, thus reducing the amount of energy consumed as compared to the prior art. Using a predictive approach may also provide for smoother movement of the carriage by allowing for simultaneous movement of the azimuth and altitude motors when making adjustments to the positioning of the carriage. Such an adaptive solar tracking system may also be configured to deal with cloudy or shady conditions by making predictive, precalculated motor movements until conditions warrant sensor-based movement.

Adaptive solar tracking logic may run on the processor as a main program logic and be configured to determine a desirable carriage placement using a predictive mode. The processor may direct commands to control the azimuth and altitude motors, sending appropriate signals to move the carriage to the desired location. The adaptive solar tracking logic may be configured to learn the path of the sun during a day by use of sensors, and to use a predictive mode and sensor data indicating the learned path to plot the sun's course at other points in the day using mathematical equations. Additional predictions of the sun's trajectory may be accomplished by recording the first half of a day and, once solar noon is reached during that day, using a predictive mode to replay the inverse of the first half in the second half of the day using the azimuth and altitude motors in order to generally or exactly mimic the movements of the azimuth and altitude motors during the first half of the day, except each movement is reversed. Additionally, by recording previous days solar positions, the adaptive solar tracking logic may determine if the current panel/carriage placement is the same or substantially similar to the previous day because, in some embodiments, it possible to predict the sun's position by calculating it, using the predictive mode, based on the previous day's data. Accordingly, by plotting the course of the sun and using the predictive mode to place the carriage, and the solar panel mounted on the carriage just ahead of where the sun is currently positioned. The panel may remain stationary longer than prior art and improve solar energy collection while simultaneously reducing energy consumed to perform solar tracking. The disclosed adaptive solar tracking logic may be used to overcome the limitations of pure light-sensor based trackers by using predictive mode to control carriage placement during times of shady or cloudy conditions.

The detailed description of embodiments of this present invention refer to the accompanying figures. Each figure is noted with an identifying number and each aspect within a given figure is given a unique identifying number, both of which are referenced in this description. It should be noted that while embodiments are described in sufficient detail that one skilled in the art would recognize the unique aspects as compared to prior art, the description is for the purpose of illustration only and in no way limits the scope of the invention. Embodiment details, shown in the figures, such as specific type and number of components are not the only means to practice the methods and systems shown and described.

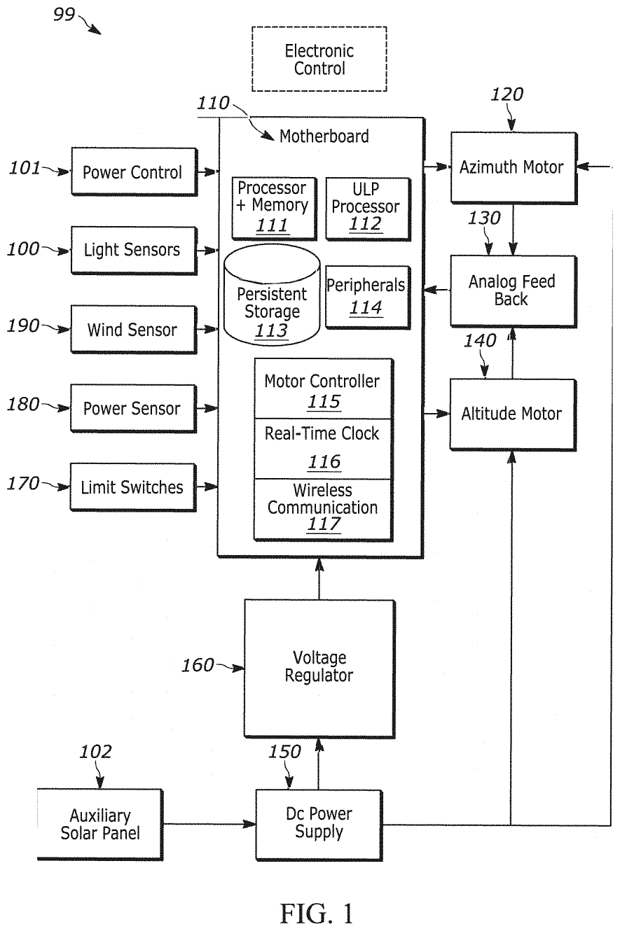

FIG. 1, shows a hardware schematic for an adaptive solar tracking system 99. The adaptive solar tracking system 99 may include light sensors 100, a power control 101, an auxiliary solar panel 102, a motherboard 110 connected to a processor and memory 111, an ultra-low power (ULP) processor 112, a persistent storage 113, peripherals 114 (e.g., a GPS unit), a motor controller 115, a real-time clock 116, wireless communication unit 117, an azimuth motor 120, an analog feedback unit 130, an altitude motor 140, a DC power supply 150, a voltage regulator 160, limit switches 170, a power sensor 180, and a wind sensor 190. The light sensors 100, wind sensor 190, power sensor 180, and power control 101 and limit switches 170 may all be configured to deliver data to the motherboard 110, for the purpose of causing the adaptive solar tracking system 99 to track the sun during a given day by actuating the azimuth motor 120 and the altitude motor 140 via the DC power supply 150 and control signals from the motherboard 110.

For example, in some embodiments, limit switches 170 may be employed to indicate when the carriage of the adaptive solar tracking system 99 has been maximally rotated in a given direction. In this way, the adaptive solar tracking system 99 may not engage the azimuth or altitude motors when there is no possibility of moving the carriage in the indicated direction. As another example, in some embodiments, the power sensor 180 provides telemetry data for power generated by the solar tracking system 99. This data may be used to monitor the effectiveness of the adaptive solar tracking system 99 over time. Additional approaches will be described in greater detail below.

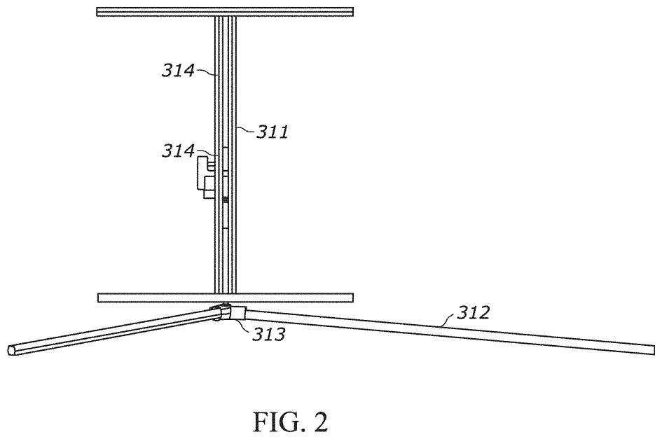

The processor and memory 111 and ULP processor 112 may be configured to analyze data received from the light sensors 100, the limit switches 170, the power sensor 180, and the wind sensor 190, the real-time clock 116, and the wireless communication unit 117 and to adjust, via the azimuth motor 120 and the altitude motor 140, a vertical and azimuth orientation of the carriage assembly (sometimes referred to as simply “carriage” herein) (FIG. 2). Adjustment of the orientation of the carriage may be carried out by the adaptive solar tracking system 99 such that, when a primary solar panel (not shown) is mounted to the carriage, the carriage is adjusted to hold the solar panel in a desirable placement (e.g., orientation) with respect to the sun.

The dc power supply 150 may include a battery charge circuit configured to provide the charging voltage and current required to recharge the battery pack. The dc power supply 150 may utilize a step up circuit to convert the 12v auxiliary solar panel 102 output power of the built in solar charger to a voltage required (e.g., 14 volts) to charge the battery pack. The built-in auxiliary solar panels may be a 12v 10 w trickle charger. It may also be provided with a built-in back-flow prevention diode. A nominal charge current provided by one embodiment auxiliary solar panel at peak hours may be 0.83a.

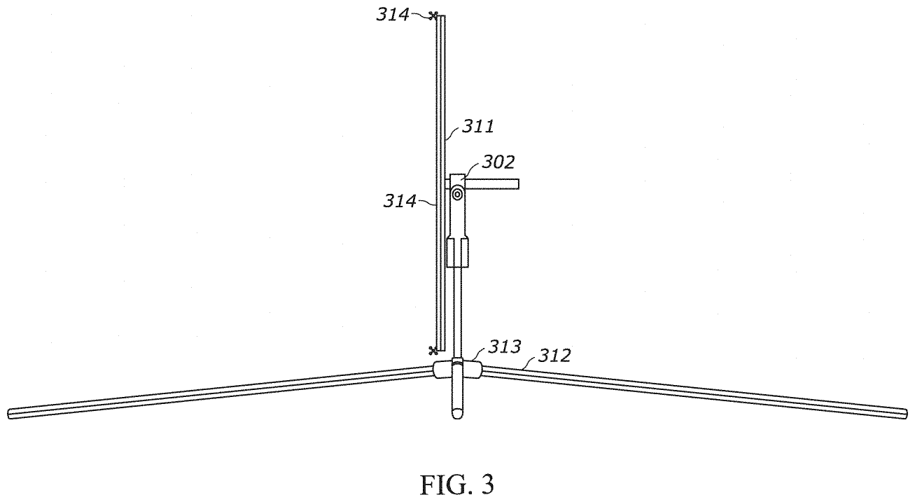

A carriage assembly 311 configured to hold a solar panel is shown in FIGS. 2 and 3. The carriage assembly 311 is mounted to the carriage mount 302 and may be configured to hold planar surfaces of various dimensions (e.g., variously sized solar panels). For example, the carriage may include adjustable arms 314 configured to be variably adjusted to securely hold variously sized solar panels (not shown). In some embodiments, the carriage mount 302 is a clamp configured to clamp onto a portion of the carriage assembly 311. In some embodiments, the carriage mount 302 is a bracket configured to accommodate mechanical fasteners (not shown) used to engage a portion of the carriage assembly 311. The base 313 may be fixed to the azimuth drive shaft (not shown). The legs 312 may be fixed within the base 313, and may be of greater or lesser quantity than shown.

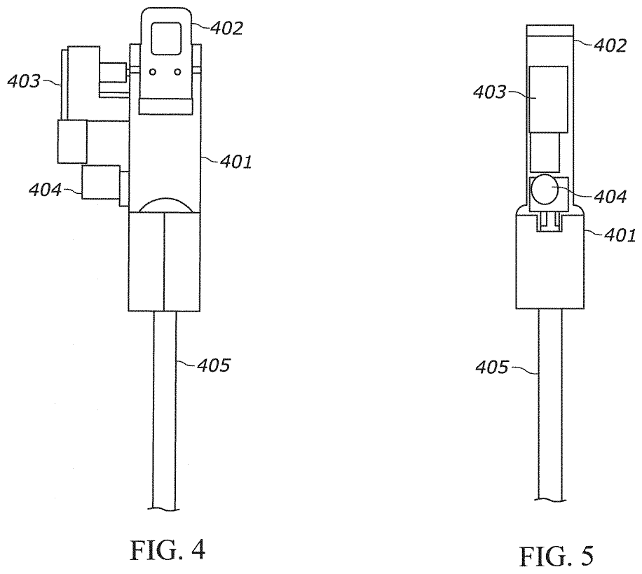

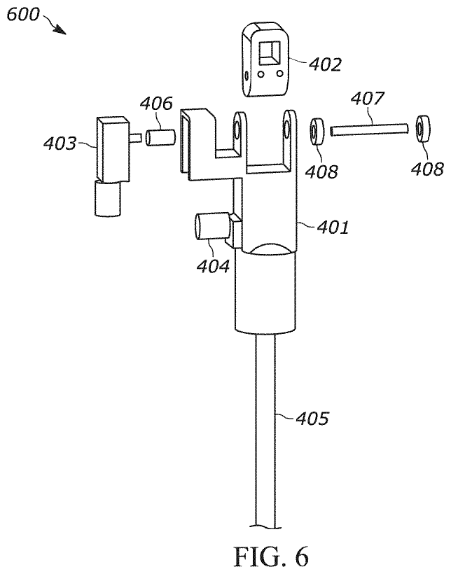

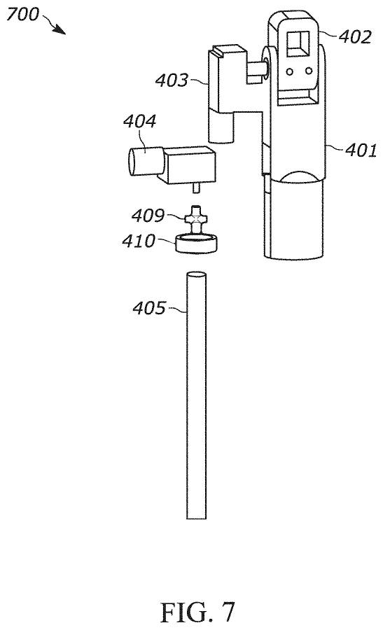

A dual axis tracking assembly housing 401 is shown in FIGS. 4-7. The dual axis tracking assembly housing 401 may contain two slots sized so that two motor and gearbox packages respectively designating altitude drive 403 and azimuth drive 404 can be friction fit into place. To assemble the altitude drive assembly 600, a shaft coupling 406 is slotted onto a shaft of the altitude drive 403 and fixed in place. The altitude drive 403 may then be fitted to the corresponding seat on the dual axis tracking assembly housing 401. The two altitude drive shaft bearings 408 may be seated into the corresponding seats in the dual axis tracking assembly housing 401. The carriage mount 302 may be placed between the altitude drive shaft bearings 408 and the altitude drive shaft 407 may be slid through into the shaft coupling 406 and fixed into place. When electrical power is applied to the altitude drive 403, torque may be transmitted through the shaft, shaft coupling 406, azimuth drive shaft 405, and carriage mount 302 which may cause the carriage mount 302 to rotate. When power is removed from the altitude drive 403, motion may cease and the position of the carriage mount 302 may be maintained via a self-locking characteristic of the altitude drive 403 gear box.

The azimuth drive assembly 700 may be assembled by inserting the azimuth flange shaft coupling 409 into the inner diameter of the azimuth drive shaft 405 and fixing them in place. The azimuth drive 404 may be slotted into the corresponding slot in the dual axis tracking assembly housing 401. The azimuth flange shaft coupling 409 and azimuth drive shaft 405 may be slid into the interior cavity of the dual axis tracking assembly housing 401 where the shaft of the azimuth drive 404 may coupled to the azimuth flange shaft coupling 409, and the azimuth drive shaft bearing 410 may be slipped over the azimuth drive shaft 405 and seated into the dual axis tracking assembly housing 401. When electrical power is applied to the azimuth drive 404, torque is transmitted through the shaft, azimuth flange shaft coupling 409, and azimuth drive shaft 405 which ultimately causes the dual axis tracking assembly housing 401 to rotate. When power is removed from the azimuth drive 404, motion may cease and position may be maintained via the self-locking characteristic of the azimuth drive 404 gear box. Although both an altitude drive 403 and an azimuth drive 404 are shown here as cooperative drivers of the adaptive solar tracking system 99, it is contemplated that the altitude drive 403 or the azimuth drive 404 could be used as a sole driver in a single-axis embodiment of the adaptive solar tracking system 99.

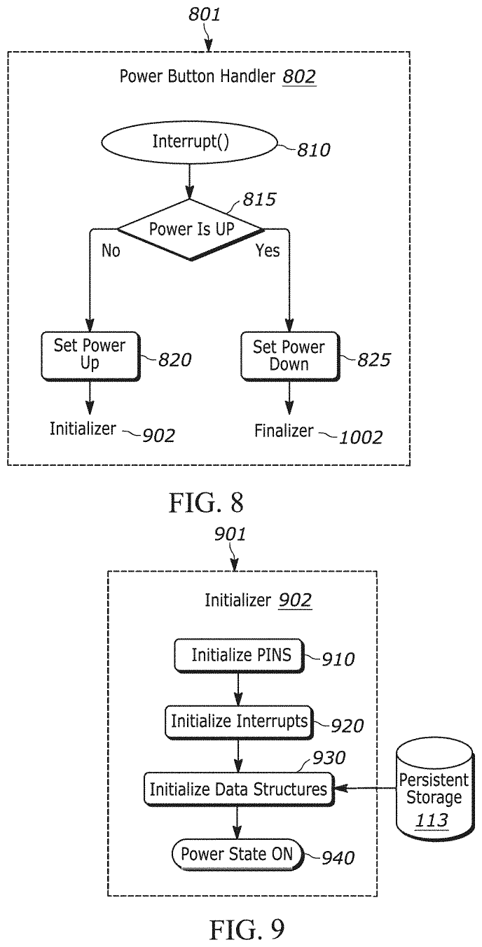

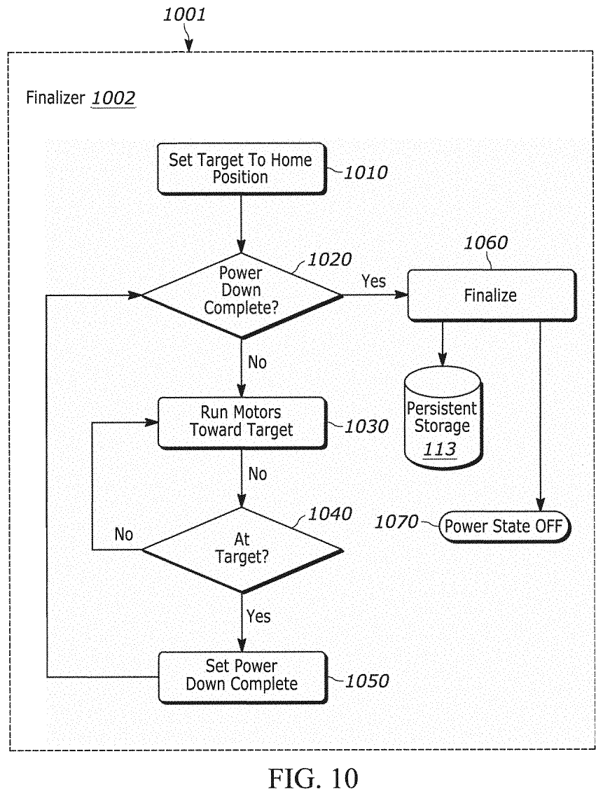

FIG. 8 shows a flowchart of logic for when the power control 101 is turned on and off, thereby turning the motherboard 110 on or off. The power control 101 may be a toggle switch, a button, a remotely controlled switch, etc. and may be configured to gate the delivery of power of power from a power source (e.g., DC power supply 150, auxiliary solar panel 102, or some other power source) to the motherboard for turning the adaptive solar tracking system 99 on. When the power control 101 is toggled, the power button handler 801 may be called, an interrupt handler 810 may handle any interrupt produced by the toggling of the power control 101, and the current power state is checked at block 815. If current power state is OFF, the program logic proceeds to block 820 to switch power state to ON, which is further described with regard to FIG. 9. If power state is ON, the program logic proceeds to block 825 to switch power state to OFF, a process which is further described in FIG. 10.

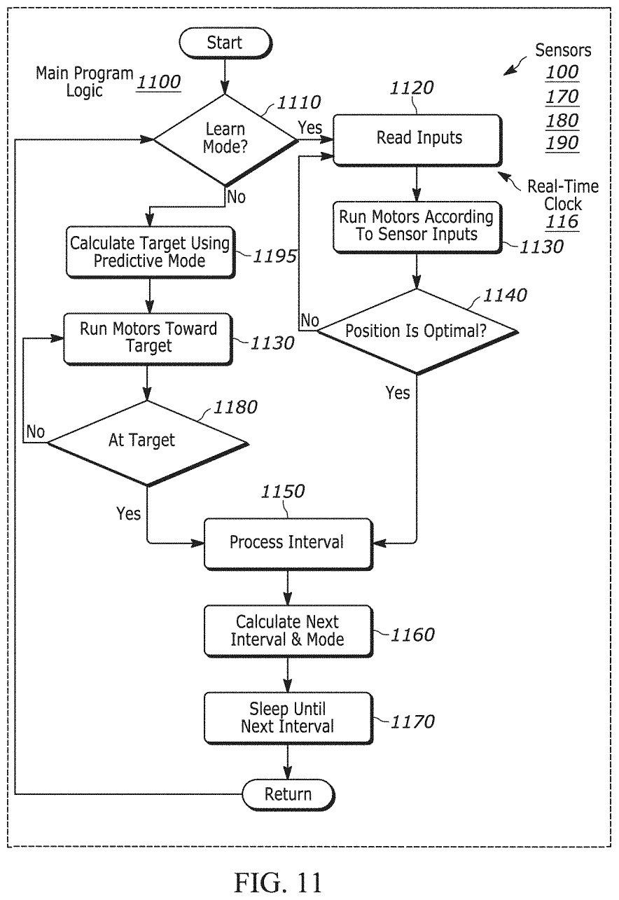

FIG. 9 shows a flowchart 901 of initializer logic 902 for when the power state is turned ON via initializer logic 902 when the power control 101 is toggled. Initializer flow chart 901 describes logic 902 that is run both as the overall initiation process as well as the Power ON handler. At block 910 PINS may be initialized, wherein specific PINS used to connect input and output devices to the at least one processor 111 are designated. At block 920, the interrupt handler is initialized, as described above with regard to FIG. 8. At block 930, data structures may be initialized by loading data from previous usage of the adaptive solar tracking system 99 from persistent storage 113 into the memory 111. These data may be used to inform the adaptive solar tracking logic illustrated in FIG. 11 (e.g., Main Program Logic 1100). At block 940, the initializer logic 902 is to set the Power State ON.

FIG. 10 shows a flowchart 1001 of finalizer logic 1002 configured to perform a power down function continuing from the power down 825 function described above with regard to FIG. 8. At block 1010, a target orientation for the carriage assembly 311 may be set to the home position. The “home position” may be a fully retracted and azimuth position, parallel to a ground surface. At block 1020, the finalizer logic 1002 may determine whether the power down process has completed. If the power down process has completed, the finalizer logic 1002 may continue to block 1060. If the power down process has not completed, the finalizer logic 1002 may continue to block 1030 wherein an iterative loop may be run to adjust the azimuth and altitude motors toward a target position (e.g., a carriage assembly 311 orientation target). At block 1040, the finalizer logic 1002 may determine whether the target position has been reached. Once the target position is reached, the finalizer logic 1002 may proceed to block 1050, where a power down complete flag may be set. The finalizer logic 1002 may then return to block 1020, where the finalizer logic 1002 may proceed to block 1060 because the power down complete flag is set. At block 1060, all in-memory data structures may be written to persistent storage 113. At block 1070, the power state is set to OFF.

FIG. 11 shows a flow chart for main program logic 1100 of the adaptive solar tracking system 99. Two modes of operation are shown, namely learn mode and predictive mode. The main program logic 1100 may branch between modes in the main loop, as shown in FIG. 11. Learn mode 1110 may be useful for unexpected or changing conditions. For example, a wind sensor 190 may indicate wind speeds in excess of a preset safe value. Learn mode 1110 may be used to control the motors 120, 140 to reduce wind drag on the carriage 311 or a solar panel mounted thereon. This safeguard may protect valuable equipment from being blown over during extremely windy conditions. Predictive mode 1195 may be useful for improving capture of solar energy over a given interval of time. Predictive mode 1195 may be configured to account for a likelihood that solar radiation and rate of change in the azimuth varies at different points in the day by running the motors 120, 140 in a manner predicting these variations. Depending on the type of prediction done, the mode may switch back and forth from learn mode 1110 to predictive mode 1195 until sufficient data points exist or a desirable irradiation of a solar panel mounted on the carriage 311 is achieved.

At block 1110, the main program logic 1100 determines whether the adaptive solar tracking system 99 is in learn mode. While in learn mode, the sensors 100, 170, 180, 190 may be read on multiple iterations of the loop (e.g., every iteration) at block 1120. At block 1030, the values of the sensors 100, 170, 180, 190, for example light or power intensity readings may be used to compare against previous readings to determine the direction to run motors toward a target position. At block 1140, as the sensors are compared, a determination may be made as to whether the current position of the motors 120, 140 or carriage 311 is desirable. If the position is not yet desirable, the main program logic 1100 may return to block 1120 and additional readings from sensor 100, 170, 180, 190 may be taken. This sequence may continue iteratively until the desired position is reached. At block 1150, when the desired position is reached, the current position data may be used in process interval.

At block 1190, when the adaptive solar tracking system 99 is not in learn mode, a predictive target position may be calculated using a predictive mode without using sensors 100, 170, 180, 190. In predictive mode, at block 1130, motors 120, 140 may be run iteratively based on the predictive target position and according to sensor inputs, until the carriage 311 orientation is desirable (e.g., resulting in a carriage 311 orientation which places a solar cell surface of a solar panel mounted therein within 15 degrees of orthogonal incidence of the sun's rays upon the solar cell surface). The logic of the adaptive solar tracking system 99 may be configured to return to main program logic 1100 after the carriage 311 orientation reaches the predictive target. At block 1180, the main program logic 1100 determines whether the orientation of the carriage 311 has reached the predictive target position. Each iteration of adjusting the carriage 311 based on the predictive target position may be referred to as an interval. After an interval has been processed, another interval may be calculated in block 1160. At block 1170, the main program logic 1100 may sleep or wait until the next interval.

In some embodiments, predictive mode 1195 comprises several different methodologies, depending on time of day and amount of available data gathered while in learn mode. In such embodiments, before apparent solar noon, a mathematical approximation of the sun's path is calculated using a non-linear least squares fit for the sinusoidal model representing the sun's altitude and azimuth trajectories on a given day. The early part of the day's observed measurements from learn mode are used to feed the least squares approximation so that the next several target positions can be predictive, and a smoother path to the target is taken as compared to prior art which moves in each axis sequentially due to exclusive reliance on sensors. Each predictive movement may be used to position the solar panel just past an optimum incidence angle (e.g., an orientation of the carriage 311 resulting in an orthogonal or 0° incidence of the sun's rays upon a solar cell surface of a solar panel mounted on the carriage 311), resulting in more solar power generated while in sleep mode waiting for the next sensing and movement interval. In addition to the mathematical prediction technique, recorded data from prior days may be made available to the processor 111 via the persistent storage 113 and may be compared, by the processor 111 in the predictive mode 1195, against the current day's data being gathered in learn mode. Data stored in persistent storage 113 during operation of the adaptive solar tracking system 99 in learn mode 1110 may be used to replay the movements of the motors 120, 140 used during the previous day. For example, if the interval to interval position of the carriage 311 or solar panel is the same or substantially similar to the previous day, the predictive mode 1195 may be used to identify this fact by comparing current data with the previous day's data, replay the previous day's carriage 311 movements, and may switch periodically back to learn mode to double check the prediction data as the carriage 311 movements replay. The same concept may be applied to phases of the day. For example, as solar noon is reached and the altitude angle starts declining, the inverse of the morning's readings may be used as a predictive path for predictive target positions for the motors 120, 140 for the rest of the day with a high degree of accuracy, assuming that the sun's trajectory on any given day is uniform; comparing the delta values over time for both azimuth and altitude often confirms that the change in both axes follows a mirror pattern and thus allows the inverse of the data from the first half of the day to be used as a reliable prediction model for the second half.

Key points of carriage assembly 311 movement may be established and recorded throughout the day. For example, first light, mid-day (apparent solar noon) and last light may all be calculated and recorded in the program data structures in memory 111, or as data in persistent storage 113. A special case is so-called “bad light” which a sensor reading indicates the intensity of light is lower than expected. Bad light is in some cases due to high incidence of shadows near the end of the day, but may also be due to cloudy or shady conditions. It is possible with successive days readings to detect a pattern of bad light at the same time each day in which case the adaptive solar tracking system 99 may infer the existence of regular occurring shadows, perhaps from buildings or trees. By inferring meaning from the data, futile, excessive movement of the carriage 311 or solar panel while seeking to find light may be avoided.

Any adaptive/learned behaviors/measures, may require readings from light sensors 100 and corresponding carriage assembly 311 azimuth and altitude positioning at a number of data collection points. Each data point capture may include the relative time, light intensity, azimuth and altitude position after the carriage assembly 311 has been adjusted/moved/rotated to an optimum incidence angle to maximize solar exposure using four quadrant light sensor tracking (e.g., via the use of light sensors placed on four quadrants of the carriage 311). A minimum number of collected data points required to initiate each specific adaptive measure may vary by type and time of day the collection begins. A variety of adaptive sensing and adjustment modes are described below.

Mid-interval max: when desirable carriage assembly 311 azimuth and altitude positions are determined based on light sensor data, the desirable position may become stale with time as the earth rotates during the present sensing and adjusting interval and before the next interval sensing and adjustment are made. Predictive or adaptive movements of the motors 120, 140 may be leveraged to determine the azimuth and altitude position of the sun. The azimuth and altitude values may be calculated for the middle of the present sensing and adjusting interval to maximize the solar exposure across the interval (e.g., maximizing an average periodic solar exposure, maximizing a median periodic solar exposure, etc.), rather than maximizing only for the start of the interval.

Azimuth rotation: the relative direction of azimuth rotation of the carriage 311 may be determined within a few intervals of sensor-only adjustments. The direction of azimuth rotation may be determined by sequential iteration through previous captured data points and tracking azimuth position changes of the carriage 311. Exceptions may include: dusk, over-night, dawn and heavy shadows when either the azimuth delta is insignificant between collection points or the light intensity is too low or too dispersed to drive sensor tracking.

Previous day replay: after 24 hours of sensing and adjusting have been captured, the azimuth and altitude positions of the carriage 311 for the previous day's interval, combined with the mid-interval max and azimuth rotation information may be used to predict ideal azimuth and altitude positions for the carriage 311 for the current day's interval. Predictive calculation of desirable azimuth and altitude positions of the carriage 311 may leverage predictive mathematical curve mapping and earth's daily rotation around the sun. Calculating the azimuth and altitude average may be accomplished by sequential iteration through the current interval and next interval data point of the previous day's captured data points. While iterating through the previous day's captured data point the previous day's first light and last light relative times to accurately determine the over-night deep sleep interval for the current day to eliminate azimuth and altitude mechanical adjustments and minimizes circuitry power consumption.

Previous day shadow: in view of a previous day replay adaption and data point sequential interaction, an ultraviolet (uv) intensity of previous day's sensing during intervals may be evaluated by the adaptive solar tracking system 99 sequentially to detect multiple consecutive intervals of low ultraviolet levels preceded and followed by significantly higher levels of ultraviolet. A significant drop in ultraviolet (uv) light may indicate that a shadow adaption should be used. When the shadow duration is significant (several intervals), the potential increase in solar power capture is too small to warrant azimuth and altitude mechanical adjustments to the carriage 311 for the intervals of the shadow duration. The adaptive solar tracking system 99 may flag these suspected shadow-affected intervals in memory 111 or persistent storage 113. While the shadow persists, the potential increase in solar power capture may be too small to warrant azimuth and altitude mechanical adjustments to the carriage 311 via motors 120, 140.

Real-time shadow: placing ultraviolet (uv) sensors at opposite horizontal ends of the carriage assembly 311 may allow light sensor readings a few feet apart. The leading and trailing horizontal sensors may be determined based on the azimuth rotation direction. By sequentially iterating through a floating window of the previous interval data points and determining when a significant drop in ultraviolet intensity is detected by the leading sensor, followed shortly by a similar drop in ultraviolet intensity by the trailing sensor, a shadow cast by structure located within a 100 m may be detected. The adaptive solar tracking system 99 may flag these suspected shadow-affected intervals in memory 111 or persistent storage 113. While the shadow persists, the potential increase in solar power capture may be too small to warrant azimuth and altitude mechanical adjustments to the orientation of the carriage assembly 311 via motors 120, 140.

Mid-day max: the arc of the solar altitude through the day may result in a maximum altitude position at solar mid day with a mirrored/symmetric curve before and after. The mid-day max may be determined by the adaptive solar tracking system 99 sequentially iterating through the previous interval data points and identifying the interval (relative time) where the maximum altitude position is preceded and followed by lower altitude positions. Several intervals may have similar high altitude position, so additional calculation to find the mid point of those intervals may be performed to find an accurate mid day interval (relative time). The mid-day max interval may then be used for additional adaptions.

Replay altitude inverse: as mentioned earlier the solar arc is symmetric around mid-day max and, in some cases, the azimuth and altitude positions from all interval data points collected before solar noon may therefore be used to determine the ideal azimuth and altitude positions for the subsequent interval after mid day. The adaptive solar tracking system 99 may sequentially iterate through the data points captured prior to mid day and determine azimuth and altitude positions using mid-interval max logic described above. Additionally, the mid-day max and the current day's last light may be used to calculate the first light relative times to determine the over-night deep sleep interval for the current day to eliminate azimuth and altitude mechanical adjustments and minimize circuitry power consumption.

Interval adjustments: similar to the altitude arc maximum at mid day, the azimuth arc is also symmetric. The delta between azimuth positions at regular intervals increases from first light through mid day and decrease from mid day to last light. Consequently, a desirable time period for the carriage assembly 311 to remain at specific azimuth and altitude orientation (e.g., interval length), may be shorter during mid day hours than dawn and dusk hours. Mid-day max may be used as a reference point to calculate symmetrical interval length adjustments. The interval adjustment adaption may build on the replay altitude inverse logic's sequential iteration through the data points captured prior to mid day to not only determine ideal azimuth and altitude positions, but also desirable interval length.

Curve prediction: the azimuth and altitude movements of the sun follow a mathematical formula/equation. By sequentially mapping relative time and sensed azimuth or altitude positions of the sun as data points, the adaptive solar tracking system 99 may generate and eventually refine the mathematical formula to provide accurate mid-interval max azimuth and altitude positions.

Unit movement/correction: the adjustments described above may be dependent upon accurate sensor based adjustments and positions. The adaptive solar tracking system 99 may be configured to check adaptive movements of the carriage 311 against sensor readings to monitor accuracy and detect accidental or voluntary movement of the base unit.

It is contemplated adaptive solar tracking system 99 may also be used to predictively place a reflective panel in an optimum position in order to reflect the sun's rays onto a stationary solar panel. One of the disadvantages of stationary solar panels may be that as the sun crosses the sky, the panel may not be able to collect as much solar energy as a panel that tracks the path of the sun. However, the adaptive solar tracking system 99 may be configured to position a reflective panel such that the stationary solar panel is able to significantly increase energy production—especially during times when the sun's angle of incidence is undesirable. In one embodiment, the reflective panel is mounted adjacent to a stationary adaptive solar tracking system 99. As the sun rises in the morning, the adaptive solar tracking system may move the reflective panel into a desirable position. During times of peak energy production of the stationary panel, the reflective panel may be retracted to the home position. After the peak energy position, the reflective panel may be positioned once again to increase the solar energy production.

Although certain aspects have been described in detail with reference to certain preferred embodiments, variations and modifications exist within the scope and spirit of one or more independent aspects as described.

What is claimed is:

1. A solar tracking system comprising:
at least one processor;
a memory coupled to the at least one processor;
a carriage mount;
a carriage;
an altitude motor connected to the carriage;
an azimuth motor connected to the carriage; and,
a tracking application, residing in the memory and executed by the at least one processor, the tracking application configured to run the altitude motor and azimuth motor such that a solar panel connected to the carriage is positioned in a way to increase solar irradiation.

2. The system of claim 1 further comprising a tripod base connected to the carriage mount.

3. The system of claim 1 wherein the carriage comprises adjustable arms configured to be variably adjusted to securely hold variously sized solar panels.

4. The system of claim 1 wherein the system further includes an altitude drive comprising the altitude motor, an altitude drive shaft bearing and a shaft coupling, and wherein the altitude drive is configured to control an altitude rotation of the carriage mount.

5. The System of claim 1 wherein the system further includes an azimuth drive comprising the azimuth motor, an azimuth flange shaft coupling and at least one azimuth drive shaft bearing, and wherein the azimuth drive is configured to control an azimuth rotation of the carriage mount.

6. The system of claim 1 wherein the tracking application is further configured to calculate a plurality of predictive sun azimuth position points and a plurality of predictive sun altitude position points, and to run the altitude motor and azimuth motor based on the predictive sun azimuth position points and the predictive sun altitude position points.

7. The system of claim 1 further comprising a plurality of sensors coupled to the at least one processor, and
wherein the tracking application is further configured to track a sun by running the azimuth motor and the altitude motor based on light sensed by the plurality of sensors.

8. A solar panel mount comprising:
at least one processor;
a plurality of sensors connected to the at least on processor;
a memory coupled to the at least one processor;
persistent storage coupled to the at least one processor;
a carriage mount;
a carriage;
an altitude drive including an altitude drive shaft and an altitude motor, the altitude drive configured to control a altitude rotation of the carriage mount;
an azimuth drive including an azimuth drive shaft and an azimuth motor, the azimuth drive configured to control an azimuth rotation of the carriage mount; and,
a dual axis tracking assembly housing including the altitude drive and the azimuth drive.

9. The solar panel mount of claim 8 further comprising a tripod base connected to the carriage mount.

10. The solar panel mount of claim 8 wherein the carriage comprises adjustable arms configured to be variably adjusted to securely hold variously sized solar panels.

11. The solar panel mount of claim 8 further, wherein the altitude drive further comprises a shaft coupling and an altitude drive shaft bearing.

12. The solar panel mount of claim 8 further, wherein the azimuth drive further comprises an azimuth flange shaft coupling and an azimuth drive shaft bearing.

13. The solar panel mount of claim 8 wherein the plurality of sensors includes light sensors disposed in four quadrants of the carriage.

14. The solar panel mount of claim 8 wherein the plurality of sensors includes a power sensor.

15. A non-transitory, computer-readable medium containing instructions that when executed by an electronic processor cause the electronic processor to control rotation of a solar panel mount, by:
obtaining sun altitude data or sun azimuth data from a plurality of sensors in a learn mode;
storing the sun altitude data or the sun azimuth data in a persistent storage;
calculating plurality of predictive sun position points based on the stored sun altitude data or stored sun azimuth data; and,
running a single-axis drive to rotate the solar panel mount to a desirable position based on the predictive sun altitude position points.

16. The computer readable medium of claim 15 wherein
the single-axis drive is an azimuth drive,
the predictive sun position points are predictive sun azimuth position points based on the stored sun azimuth data, and
the azimuth drive is used to rotate the solar panel mount to a desirable azimuth position based on the predictive sun azimuth position points.

17. The computer readable medium of claim 15 wherein
the single-axis drive is an altitude drive,
the predictive sun position points are predictive sun altitude position points based on the stored sun altitude data, and
the altitude drive is used to rotate the solar panel mount to a desirable altitude position based on the predictive sun altitude position points.

18. The computer readable medium of claim 15 wherein obtaining sun altitude data or sun azimuth data from the plurality of sensors in the learn mode comprises obtaining light data using at least two light sensors from the plurality of sensors to produce light intensity data over a predetermined time interval, wherein the at least two light sensors are positioned at different locations on the solar panel mount.

19. The computer readable medium of claim 18 wherein obtaining sun altitude data or sun azimuth data from the plurality of sensors in the learn mode comprises obtaining light data using at least two light sensors from the plurality of sensors to produce light intensity data over a predetermined time interval, wherein the at least two light sensors are positioned at different locations on the solar panel mount.

20. The computer readable medium of claim 19 further comprising instructions that when executed by the electronic processor cause the electronic processor to control rotation of the solar panel mount, by:
detecting persistent shadows based on the light intensity data over a predetermined time interval; and,
running the altitude drive to rotate the solar panel mount to a desirable altitude position based on the detected persistent shadows.
